(19) United States
(12) Patent Application Publication
(10) Pub. No.: US 2025/0390825 A1
(43) Pub. Date: Dec. 25, 2025

(54) SYSTEM AND METHOD FOR CONVERSATIONAL GENERATIVE AI DRIVEN UNDERWRITING ASSISTANT

(71) Applicants: Shekar Pannala, Plainsboro, NJ (US); Andrew Zarkowsky, Skokie, IL (US)

(72) Inventors: Shekar Pannala, Plainsboro, NJ (US); Andrew Zarkowsky, Skokie, IL (US)

(21) Appl. No.: 18/922,914

(22) Filed: Oct. 22, 2024

Related U.S. Application Data
(60) Provisional application No. 63/662,487, filed on Jun. 21, 2024.

(51) Int. Cl. G06Q 10/0635; G06F 16/22; G06F 16/332; G06F 16/34

(52) U.S. Cl. CPC G06Q 10/0635; G06F 16/2237; G06F 16/3329; G06F 16/345

(57) ABSTRACT

A back-end application computer server may receive a risk relationship analysis request from a user device. The computer server may then extract and summarize information, by a data extractor using deep learning and natural language processing from multiple data sources (including knowledge graphs, websites, and historical loss reports). A response generator may then generate an accurate and contextually relevant response based on the extracted data and information in a risk relationship data store. The risk relationship data store may, for example, contain electronic records associated with a plurality of risk relationships between the enterprise and parties. The relevant response can then be transmitted to the user device.

### CROSS-REFERENCE TO RELATED APPLICATIONS

The present application claims the benefit of U.S. Provisional Patent Application No. 63/662,487 entitled “SYSTEM AND METHOD FOR CONVERSATIONAL GENERATIVE AI DRIVEN UNDERWRITING ASSISTANT” and filed Jun. 21, 2024. The entire content of that application is incorporated herein by reference.

### TECHNICAL FIELD

The present application generally relates to computer systems and more particularly to computer systems that are adapted to accurately, securely, and/or automatically utilize a multi-agent Artificial Intelligence-driven system for risk analysis leveraging advanced data extraction and response generation techniques.

### BACKGROUND

An enterprise may enter into risk relationships with various parties (e.g., people or businesses). Moreover, the enterprise may perform a risk analysis to determine, for example, the likelihood and/or magnitude of various occurrences. For example, an insurer may perform “underwriting” which is a complex process involving the evaluation of risk, verification of data consistency, identification of missing information, generation of recommendations, etc. Traditional underwriting systems assess the risks manually based on collected data and personal judgment. However, such an approach is time-consuming, prone to human error, and may lack consistency. A rule-based underwriting systems might use “if-then logic” to apply predefined rules and criteria when assessing risks. These systems are inflexible (e.g., unable to adapt to complex or novel scenarios) and require constant updates to the rules. A statistical model approach to underwriting uses statistical techniques, such as regression analysis, to predict risk and actuarial models that rely on historical data to estimate probabilities. However, statistical models heavily depend on historical data and may not account for new or changing risk factors. Machine Learning (“ML”) models for underwriting may analyze large datasets and predict risk. Most of these ML approaches, however, are black box models that require large amounts of data (and may suffer from biases present in the training data).

Natural Language Processing (“NLP”) techniques are used for document analysis to extract and analyze information from unstructured text documents. For instance, NLP techniques may be useful for parsing insurance policies to extract relevant information. The capabilities of these techniques are limited to text data and may struggle with understanding context or tones in language. Knowledge graphs are useful for information retrieval as well as to organize and retrieve interconnected information. In the underwriting process, knowledge graphs may be used to link various data points and provide a comprehensive view of the risk. However, building and maintaining knowledge graphs can be resource-intensive, and they might not capture all relevant relationships.

Expert-based underwriting systems encode the knowledge and decision-making processes of human experts. These systems mimic the decision-making of experienced underwriters through predefined rules and heuristics. However, these systems possess limited adaptability and scalability and are heavily reliant on the initial knowledge encoded by experts.

Thus, traditional approaches to the underwriting process are labor-intensive and prone to human error. It would be desirable to provide improved systems and methods to accurately and/or automatically utilize risk relationship analysis tools for an enterprise. Moreover, the results should be easy to access, understand, interpret, update, etc.

### SUMMARY OF THE INVENTION

According to some embodiments, systems, methods, apparatus, computer program code and means are provided to accurately and/or automatically provide enterprise risk relationship analysis tools for an enterprise in a way that provides fast, secure, and useful results and that allows for flexibility and effectiveness when responding to those results.

Some embodiments are directed to an enterprise risk relationship analysis system implemented via a back-end application computer server. The computer server may receive a risk relationship analysis request from a user device. The computer server may then extract and summarize information, by a data extractor using deep learning and natural language processing from multiple data sources (including knowledge graphs, websites, and historical loss reports). A response generator may then generate an accurate and contextually relevant response based on the extracted data and information in a risk relationship data store. The risk relationship data store may, for example, contain electronic records associated with a plurality of risk relationships between the enterprise and parties. The relevant response can then be transmitted to the user device.

Some embodiments comprise: means for receiving, by a computer processor of a back-end application computer server, a risk relationship analysis request from a user device; means for extracting and summarizing information, by a data extractor using deep learning and natural language processing from multiple data sources, including knowledge graphs, websites, and historical loss reports; means for generating, by a response generator, an accurate and contextually relevant response based on the extracted data and information in a risk relationship data store; and means for transmitting the relevant response to the user device.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized enterprise risk relationship analysis for an enterprise that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of an enterprise risk relationship analysis system in accordance with some embodiments.

FIG. 2 illustrates a high-level enterprise risk relationship analysis method according to some embodiments.

FIG. 3. shows high-level goals of a conversational generative AI-driven underwriting system in accordance with some embodiments.

FIG. 4 illustrates AI inclusion in the underwriting process according to some embodiments.

FIG. 5 is a run-time system architecture illustrating the components and data flow in accordance with some embodiments.

FIG. 6 is the system level components for a data extractor and response generator according to some embodiments.

FIG. 7 is a block diagram of an apparatus in accordance with some embodiments.

FIG. 8 is a portion of a tabular risk analysis database according to some embodiments.

FIG. 9 is an operator or administrator display in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with enterprise risk relationship analysis. The present invention is directed to more than merely a computer implementation of a routine or conventional activity previously known in the industry as it provides a specific advancement in the area of electronic record analysis by providing improvements in the operation of a computer system that customizes enterprise risk relationship analysis (including those associated with risk relationships). The present invention provides improvement beyond a mere generic computer implementation as it involves the novel ordered combination of system elements and processes to provide improvements in the speed, security, and accuracy of such an enterprise risk relationship analysis tool for an enterprise. Some embodiments of the present invention are directed to a system adapted to automatically customize and execute enterprise risk relationship analysis, aggregate data from multiple data sources, automatically generate risk relationship analysis information to reduce unnecessary messages or communications, etc. (e.g., to consolidate communications between parties). Moreover, communication links and messages may be automatically established, aggregated, formatted, modified, removed, exchanged, etc. to improve network performance (e.g., by reducing an amount of network messaging bandwidth and/or storage required to create enterprise risk relationship analysis messages or alerts, improve security, reduce the size of data stores, more efficiently collect, present, and utilize risk relationship analysis information, etc.).

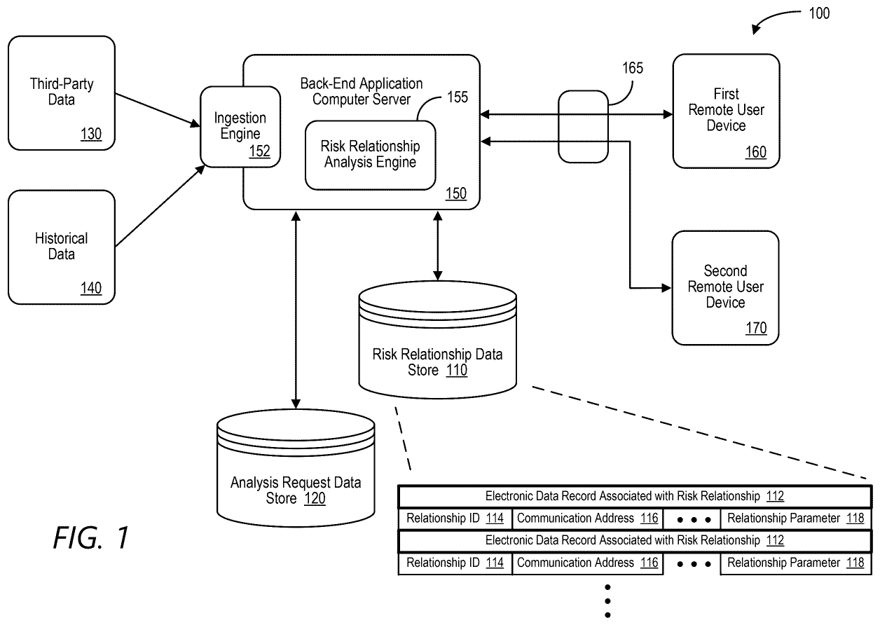

FIG. 1 is a high-level block diagram of an enterprise risk relationship analysis system 100 that may be provided according to some embodiments of the present invention. In particular, the system 100 includes a back-end application computer server 150 that may access information in a risk relationship data store 110 (e.g., storing a set of electronic records associated with various risk relationships 112, each record including, for example, one or more relationship identifiers 114, communication addresses 116, relationship parameters 118, etc.). The back-end application computer server 150 may also store information into other data stores, such as an analysis request data store 120, and utilize an ingestion engine 152 and a risk relationship analysis engine 155 to exchange and process messages and view, analyze, and/or update the electronic records. The back-end application computer server 150 may also exchange information with a first remote user device 160 and a second remote user device 170 (e.g., via a firewall 165). According to some embodiments, an interactive graphical user interface platform of the back-end application computer server 150 may facilitate the creation and review of enterprise risk relationship analysis, recommendations, alerts, and/or the display of results via one or more remote administrator computers (e.g., to summarize system 100 performance) and/or the remote user devices 160, 170. For example, the first remote user device 160 may transmit annotated and/or updated information to the back-end application computer server 150. Based on the updated information, the back-end application computer server 150 may adjust data in the risk relationship data store 110 and/or the analysis request data store 120 and the change may (or may not) be used in connection with the second remote user device 170. Note that the back-end application computer server 150 and/or any of the other devices and methods described herein might be associated with a third party, such as a vendor that performs a service for an enterprise. In some cases, the ingestion engine 152 may receive information from third-parties 130 and/or agents 140.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate the automated access and/or update of electronic records in the data stores 110, 120 and/or the management of analysis requests. As used herein, the term “automated” may refer to, for example, actions that can be performed with little (or no) intervention by a human.

Devices, including those associated with the back-end application computer server 150 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the risk relationship data store 110 and/or the analysis request data store 120. The data stores 110, 120 may be locally stored or reside remote from the back-end application computer server 150. As will be described further below, the risk relationship data store 110 may be used by the back-end application computer server 150 in connection with an interactive user interface to access and update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and risk relationship data store 110 might be co-located and/or may comprise a single apparatus.

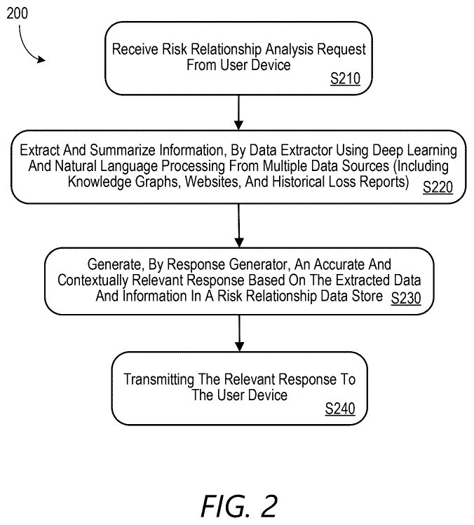

The elements of the system 100 may work together to perform the various embodiments of the present invention. Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may receive (e.g., by a computer processor of a back-end application computer server) a risk relationship analysis request from a user device. At S220, the system may extract and summarize information, by a data extractor using deep learning and natural language processing from multiple data sources (including knowledge graphs, websites, and historical loss reports). At S230, a response generator may generate an accurate and contextually relevant response based on the extracted data and information in a risk relationship data store. Finally, at S240 the relevant response can be sent to the user device.

In this way, embodiments may use a Conversational Generative AI Driven Underwriting Assistant (“CG-AIUA”). The provided system may utilize a multi-agent system designed to enhance the underwriting process by leveraging deep learning, NLP, and advanced data extraction techniques. The CG-AIUA provides accurate, efficient, and contextually relevant information to underwriters. The methods provided for a data extractor and a response generator employ deep learning, NLP, and generative AI to triangulate data from multiple sources, detect inconsistencies, and provide actionable insights. Specialized Neuro-Symbolic Large Language Model (“NS-LLM”) agents interact with a neuro-symbolic reasoning Engine to generate comprehensive guidance, open questions, and summaries.

The inclusion of AI in underwriting processes offers the potential for increased efficiency, accuracy, and enhanced decision-making capabilities. The CG-AIUA multi-agent system may assist underwriters by addressing the complexities inherent in the underwriting process. The system comprises a data extractor and a response generator, employing deep learning, NLP, and generative AI techniques, to triangulate data from multiple sources, detect inconsistencies, and provide actionable insights.

Embodiments may be designed to enhance the underwriting process by leveraging deep learning, NLP, and advanced data extraction techniques. The CG-AIUA provides accurate, efficient, and contextually relevant information to underwriters. The CG-AIUA runtime architecture might comprise, for example, a data extractor and a response generator.

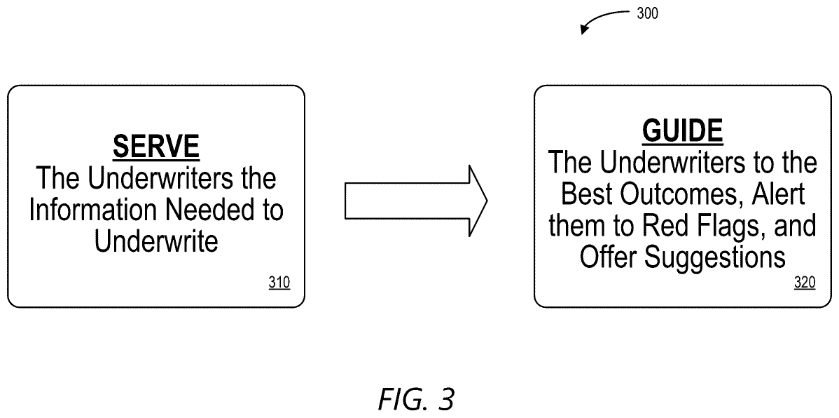

FIG. 3. shows high-level goals 300 of a conversational generative AI-driven underwriting system in accordance with some embodiments. In particular, the goals 300 include: (1) serving the underwriters with the information needed to underwrite 310, and (2) guiding the underwriters to the best outcomes, alert them to red flags, and offer appropriate suggestions 320.

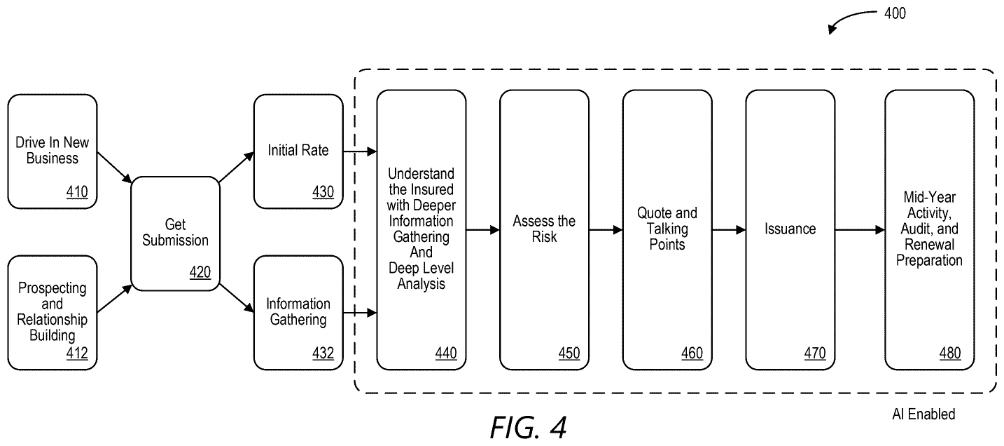

FIG. 4 illustrates AI inclusion in an underwriting process 400 according to some embodiments. In initially, the process begins with efforts to drive in new business 410 along with prospecting and relationship building 412 that lead to receiving an insurance submission 420. In response to the submission 420, an underwriter may determine an initial rate 430 and gather the relevant information 432 about the potential client. At that point, an AI enabled workflow may be used to enhance the underwriting process 400. In particular, steps may be taken to better understand the insured 440 (e.g., via deeper information gather and a deep level analysis). The system may then assess the risk 450, generate a quote and talking points 460 and eventually issue an insurance policy 470. After the policy is issued, various mid-year activities might be performed 480, such as by performing an audit, preparing a renewal application, etc.

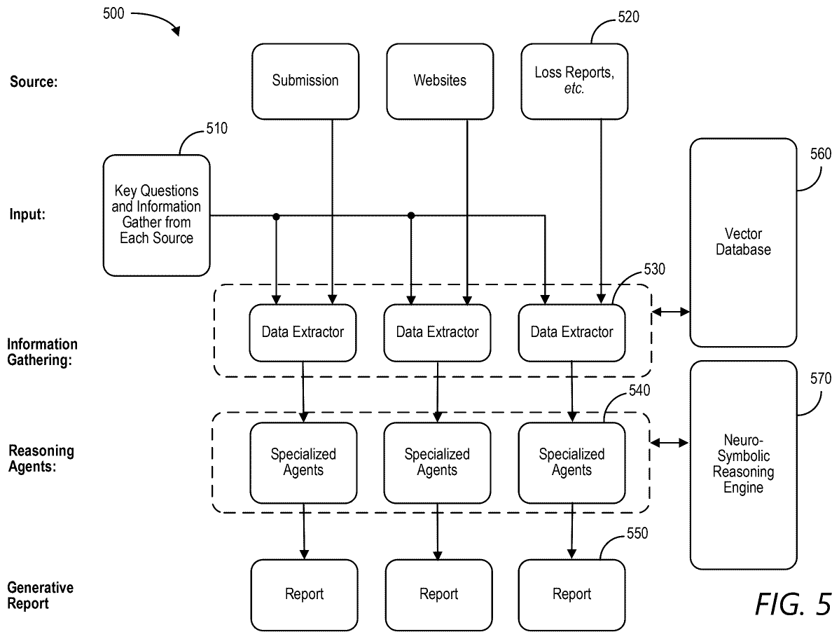

FIG. 5 is a run-time system architecture 500 illustrating the components and data flow in accordance with some embodiments. Information from various sources 520 (e.g., a submission, websites, loss reports, etc.) along with key questions and information gathering data 510 to data extractors 530 that perform information gathering tasks. The gathered information is then processed by sets of specialized agents 540 that generate reports 550 (e.g., including underwriter guidance, open questions if any, a summary of the risk, etc.). The data extractors 530 may exchange information with a vector database 560 (e.g., to support Retrieval-Augmented Generation (“RAG”) and improve domain-specific responses of an LLM), and the specialized agents may utilize a neuro-symbolic reasoning engine 570. As used herein, the phrase “neuro-symbolic reasoning” might refer to a type of AI that integrates neural and symbolic architectures to provide a robust AI that is capable of reasoning, learning, and cognitive modeling.

The data extractor is a sophisticated system designed to extract comprehensive and accurate information. The input to the data extractor consists of the key questions and information gathered 510 from each data source 520, such as knowledge graphs available on websites and historical loss reports. The data extractor captures required enterprise data from these sources, translates it into embeddings, and stores it in the vector database 560. It integrates multiple parallel approaches, powered by Deep Learning (“DL”) and NLP, to address different aspects of user questions or investigations, ensuring accurate and efficient information extraction and summarization. The agents 540 are specialized NS-LLM agents that take input from each data extractor 530 and use the input given to the data extractor 530 (that is, key questions and information gathered 510 from each data source 520). These agents 540 interact with the neuro-symbolic reasoning engine 570 and generate a response such as the report 550.

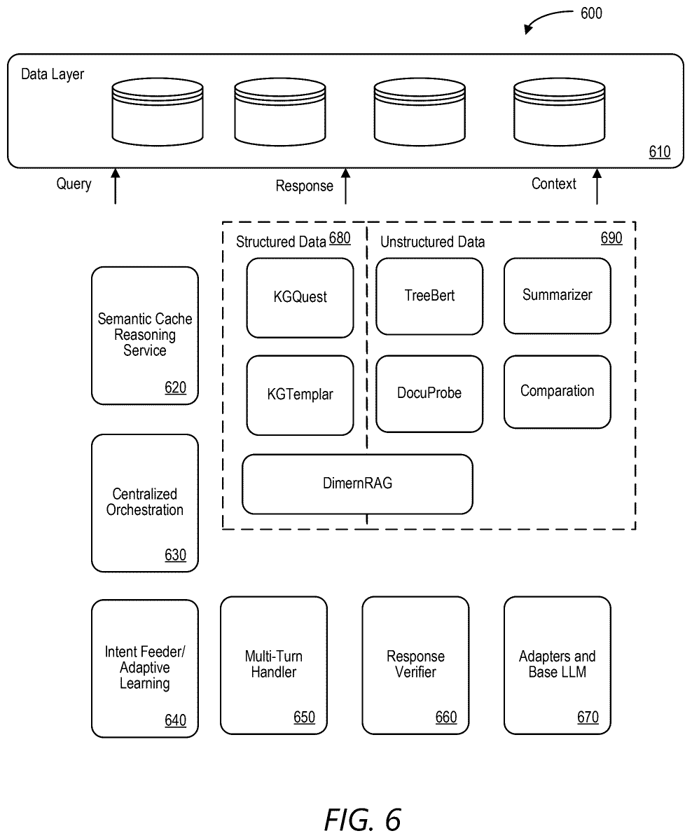

FIG. 6 is the system level components 600 for a data extractor and response generator according to some embodiments. A data layer 610 may provide information to a semantic cache reasoning service 620. A centralized orchestration component 630 may organize the operation of the semantic cache reasoning service 620, an intent feeder/adaptive learning component 640, a multi-turn handler 650, a response verifier 660, and adapters of a base LLM 670. The system might incorporate both structured data 680 (e.g., KGQuest and KGTemplar) and unstructured data 690 (e.g., TreeBert, DocuProbe, Summarizer, and comparation). Some components may incorporate bother structured data 680 and unstructured data 690 (e.g., DimernRAG).

The key architectural components of the CG-AIUA system include the semantic cache reasoning Service 630, the centralized orchestration 630, KGQuest, TreeBERT, DocuProbe, DimenRAG, the abstractive summarizer, and verification mechanisms to ensure the reliability of responses. The components 600 are designed to optimize the complex and multifaceted underwriting process through a highly structured and integrated approach. At the heart of the architecture, the semantic cache reasoning service 620 uses an in-memory cache to store and retrieve frequently accessed information. This may speed up inference times, especially for repetitive queries, thereby enhancing the overall efficiency of the system. By reducing the need to repeatedly access slower storage mechanisms, this component 620 ensures that high-demand data is always readily available, streamlining the underwriting workflow.

The centralized orchestration 630 includes an intent classifier and a centralized flow controller. The intent classifier is responsible for accurately interpreting the purpose behind user queries, enabling the system to channel the request to the appropriate processing units. The centralized flow controller then manages the flow of information through the system, coordinating the various components 600 to ensure seamless operation. This orchestration layer 630 helps maintain a cohesive system where each part functions harmoniously, preventing bottlenecks and ensuring that data processing and response generation are both timely and accurate.

The architecture also incorporates KGQuest, a tool that leverages LLMs to transform user queries into Knowledge Graph (“KG”) queries. This component facilitates the extraction of information from structured data sources, providing a robust mechanism for accessing and integrating knowledge from diverse repositories. TreeBERT is a specialized module designed to navigate hierarchical document structures with precision. It excels at extracting relevant data from complex, layered documents (including complex tables, co-referenced named entities, and semantically dependent on sentences/phrases at different hierarchies), ensuring that pertinent information is captured and used in the underwriting process.

To further enhance information retrieval, the system includes DocuProbe, which generates synthetic questions based on existing artifacts and key questions from domain experts. This module is instrumental in document-centric content extraction, ensuring that the system can anticipate and address potential information gaps by proactively querying the data. Embodiments may incorporate a multi-dimensional RAG (DimenRAG) to improve data retrieval. This component enhances the system's ability to access and integrate information from various dimensions and perspectives (ensuring a comprehensive and nuanced understanding of the data).

The summarizer component distils the extracted information into concise and actionable summaries. This abstractive summarizer is capable of generating summaries based on specific templates, ensuring that the information is presented in a format that is most useful to the underwriters. To improve the accuracy and reliability of responses, the architecture includes a Multi-stage LLM Preference (“MLP”), referred to as a response verifier 660, which rigorously checks the generative responses against domain knowledge to prevent the dissemination of erroneous or hallucinated information.

Finally, a Stage-level Human Preference (“SHP”), referred to as the intent feeder 640, provides a continuous stream of feedback to the intent classifier. This feedback loop may help provide for the system's ongoing improvement, allowing it to adapt and refine its understanding of user intents over time. By integrating human preferences into the AI's decision-making process, SHP ensures that the system remains aligned with the practical needs and expectations of its users (thereby enhancing its effectiveness and reliability in the underwriting process).

In another embodiment, Neuro-Symbolic LLM (“NS-LLM”) agents play a pivotal component within the CG-AIUA system, which is designed to enhance the accuracy and comprehensiveness of the underwriting process through data analysis and reasoning. These agents leverage the strengths of both neural and symbolic AI approaches, combining the powerful pattern recognition capabilities of deep learning with the structured logic and interpretability of symbolic reasoning. This hybrid approach enables NS-LLM agents to process and understand complex underwriting queries more effectively. NS-LLM agents take input from a data extractor, which includes key questions and pertinent information gathered from various data sources such as knowledge graphs, websites, and historical loss reports. By converting this input into embeddings and storing it in a vector database, the data extractor ensures that the information is readily accessible and in a format suitable for further analysis by the NS-LLM agents. These agents utilize the embeddings to comprehend the intent, context, and tone of the information, allowing them to generate responses that are both contextually relevant and highly accurate.

The NS-LLM agents interact with the neuro-symbolic reasoning engine, a component that combines neural network-based inference with symbolic reasoning capabilities. This interaction is crucial for generating responses that not only provide direct answers but also incorporate logical reasoning and domain-specific knowledge. The neuro-symbolic reasoning engine enhances an agent's ability to perform complex reasoning tasks, such as identifying inconsistencies between data sources, detecting unusual characteristics compared to industry benchmarks, and highlighting missing information.

In addition to direct answers, the responses generated by NS-LLM agents may include comprehensive guidance, open questions, and summaries. The guidance provided helps underwriters make informed decisions by offering expert recommendations and insights derived from the data analysis. Open questions are designed to prompt further investigation and clarify ambiguities, ensuring that underwriters consider all relevant aspects before finalizing their decisions. Summaries offer concise and coherent overviews of the extracted information, presenting it in an easily digestible format that highlights the key points and findings.

The integration of NS-LLM agents into the AIUA system enhances the overall efficiency and effectiveness of the underwriting process. By automating the extraction, analysis, and synthesis of vast amounts of data, these agents significantly reduce the time and effort required for manual data processing. This allows underwriters to focus on higher-level decision-making tasks, leveraging the advanced insights provided by the NS-LLM agents to improve the quality and reliability of their assessments. The neuro-symbolic approach also ensures that the system remains adaptable and robust, capable of handling diverse and evolving data sources while maintaining high standards of accuracy and interpretability.

The CG-AIUA system employs two innovative evaluation strategies (SHP and MLP) to ensure the quality and relevance of the output generated. These strategies work in tandem to assess and enhance the performance of the AIUA system.

SHP involves continuous feedback from human experts at every stage of the output generation process. Human evaluators assess the variability, coherence, and domain appropriateness of the content, providing valuable insights that guide the training process of the AI models. This stage-level evaluation ensures that the output aligns with industry standards and meets the specific needs of the underwriters. The emphasis on human feedback helps the system learn from real-world applications and adapt to the nuances of the underwriting domain.

MLP employs one or more advanced LLMs to evaluate the quality of the output in real-time by comparing it with similar ground truth texts. This automated evaluation strategy enables the system to perform a detailed analysis of the content's accuracy, relevance, and overall quality. By leveraging the capabilities of LLMs, MLP ensures that the CG-AIUA system maintains high standards of precision and reliability, providing outputs that are directly comparable to expert-generated references.

The output generated by the CG-AIUA system can be used by both human evaluators and LLM agents over human-written references. This indicates the effectiveness of dual evaluation strategies in producing high-quality, contextually relevant content that meets the stringent demands of the underwriting process.

To simulate the underwriting process effectively, the AIUA team comprises a diverse array of roles, each with specific responsibilities.

Senior underwriters oversee the content production process, setting underwriting standards, guiding analysts, and ensuring that the content aligns with the company's objectives. They play a crucial role in maintaining the integrity and accuracy of the underwriting decisions.

Analysts, often junior editors, work closely under the guidance of senior underwriters. Their duties include managing the day-to-day editorial workflow, editing content, assisting in content planning, and handling communications with various other roles within the organization. Analysts ensure that the workflow is smooth and that the content is thoroughly reviewed and accurate.

Translators convert written material from one language to another, preserving the tone, style, and context of the original text. They must have a deep understanding of both the source and target languages and familiarity with the subject matter to ensure accurate and meaningful translations.

Vertical Industry Specialists adapt content for specific verticals, regions, or markets. They ensure that the language, domain references, idioms, and images resonate with the target industry audience, making the content more relevant and engaging.

Proofreaders perform final checks for grammar, spelling, punctuation, and formatting errors. Their role is crucial in ensuring that the content is polished and adheres to high-quality standards before publication.

Evaluators are judgment agents responsible for assessing the quality of the underwriting and determining if further revision is needed. They may recommend additional reasoning based on the collected information, using risk formulas and other underwriting criteria. Evaluators ensure that the final output is accurate, comprehensive, and meets the required standards.

The present invention incorporates Program-Aided LLMs (“PAL”) which integrate code with text to capture the required reasoning. Once the code is executed by the corresponding engine (e.g., a Python interpreter), the reasoning results become available. This innovative method allows for sophisticated and precise reasoning capabilities, enhancing the overall effectiveness of the CG-AIUA system in supporting underwriting decisions.

The system and methods described herein encompass the detailed architecture, components, and evaluation strategies of the CG-AIUA system, highlighting its innovative approach to enhancing the underwriting process through advanced AI technologies and structured human involvement.

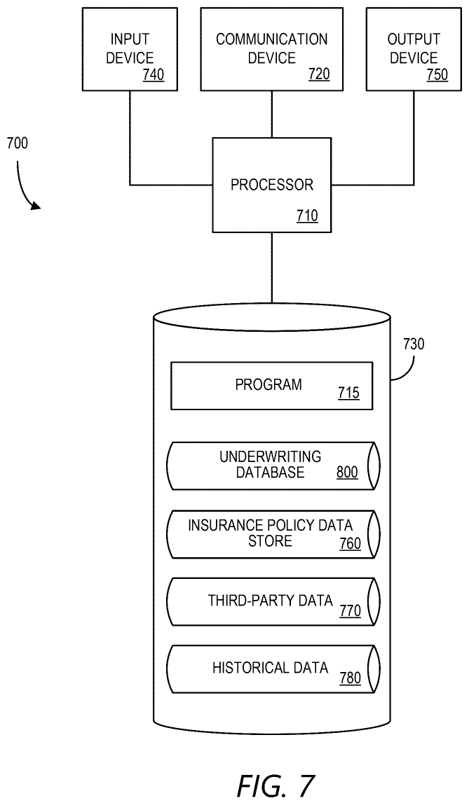

The embodiments described herein may be implemented using any number of different hardware configurations. For example, FIG. 7 illustrates an apparatus 700 that may be, for example, associated with the system 100 described with respect to FIG. 1 (or any other system described herein). The apparatus 700 comprises a processor 710, such as one or more commercially available Central Processing Units (“CPUs”) in the form of one-chip microprocessors, coupled to a communication device 720 configured to communicate via a communication network (not shown in FIG. 7). The communication device 720 may be used to communicate, for example, with one or more remote third-party devices, underwriter devices, web-based tools, administrators, enterprise employees, and/or communication devices (e.g., PCs and smartphones). Note that communications exchanged via the communication device 720 may utilize security features, such as those between a public internet user and an internal network of an insurance company and/or an enterprise. The security features might be associated with, for example, web servers, firewalls, and/or PCI infrastructure. The apparatus 700 further includes an input device 740 (e.g., a mouse and/or keyboard to enter information about underwriting requests, enterprise risk relationship analysis rules or preferences, communication addresses, etc.) and an output device 750 (e.g., to output reports regarding an enterprise risk relationship analysis, recommendations, alerts, etc.).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 715 and/or an enterprise risk relationship analysis tool or application for controlling the processor 710. The processor 710 performs instructions of the program 715, and thereby operates in accordance with any of the embodiments described herein. For example, the processor 710 may receive a risk relationship analysis request from a user device. The processor 710 may then extract and summarize information, by a data extractor using deep learning and natural language processing from multiple data sources (including knowledge graphs, websites, and historical loss reports). A response generator may then generate an accurate and contextually relevant response based on the extracted data and information in a risk relationship data store. The relevant response can then be transmitted by the processor 710 to the user device.

The program 715 may be stored in a compressed, uncompiled and/or encrypted format. The program 715 may furthermore include other program elements, such as an operating system, a database management system, and/or device drivers used by the processor 710 to interface with peripheral devices.

As used herein, information may be “received” by or “transmitted” to, for example: (i) the apparatus 700 from another device; or (ii) a software application or module within the apparatus 700 from another software application, module, or any other source.

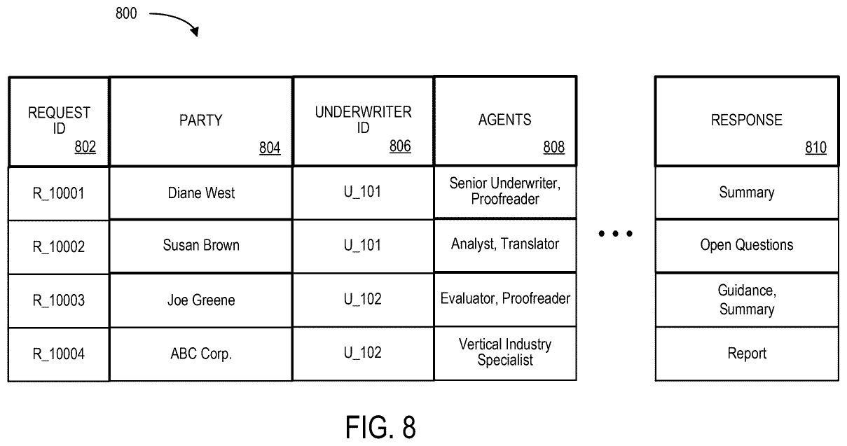

In some embodiments (such as shown in FIG. 7), the storage device 730 further includes an underwriting database 800, an insurance policy data store 760, third-party data 770, and historical data 780 (e.g., associated with prior losses). An example of a database that might be used in connection with the apparatus 700 will now be described in detail with respect to FIG. 8. Note that the database described herein is only an example, and additional and/or different information may be stored therein. Moreover, various databases might be split or combined in accordance with any of the embodiments described herein. For example, the insurance policy data store 760 and third-party data 770 might be combined and/or linked to each other within the program 715.

Referring to FIG. 8, a table is shown that represents the underwriting database 800 that may be stored at the apparatus 700 according to some embodiments. The table may include, for example, entries associated with analysis requests that have been provided to an enterprise. The table may also define fields 802, 804, 806, 808, 810 for each of the entries. The fields 802, 804, 806, 808, 810 may, according to some embodiments, specify: a request identifier 802, a party 804, an underwriter identifier 806, agents 808, and a response 810. The underwriting database 800 may be created and updated, for example, when a new request is created or an existing request is updated in connection with an insurer or business.

The request identifier 802 may be, for example, a unique alphanumeric code identifying a risk relationship analysis request that has been submitted to a CG-AIUA. The party 804 may represent a potential insured, and the underwriter identifier 806 might indicate who submitted the request. The agents 808 might be associated with various underwriting roles, such as a senior underwriter, an analyst, a translator, a proofreader, an evaluator, etc. The response 810 might indicate the automatically generated report, including, for example, a summary, open questions, guidance, etc.

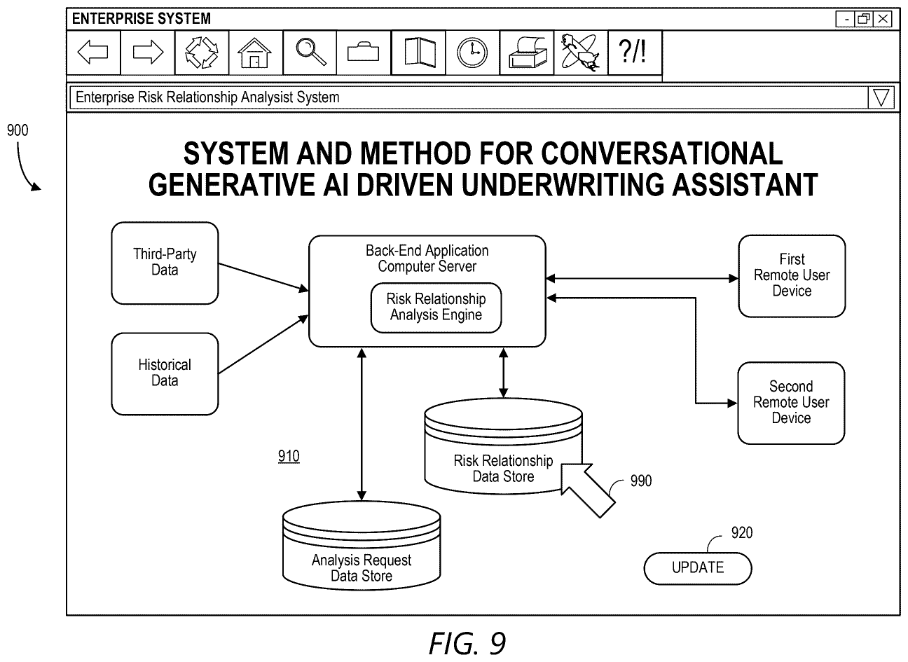

The operation of the enterprise risk relationship analysis system may be controlled via a Graphical User Interface (“GUI”). For example, FIG. 9 is an enterprise risk relationship analysis operator or administrator display 900 including graphical representations of elements of such a tool 910 according to some embodiments. Selection of a portion or element of the display 900 via a touchscreen or pointer 990 might result in the presentation of additional information about that portion or element (e.g., a popup window presenting data mappings, analysis request or insurance policy details, etc.) or let an operator or administrator enter or annotate additional information about an analysis (e.g., based on his or her experience and expertise). An “Update” icon 920 might initiate an enterprise risk relationship analysis process.

Thus, embodiments may provide improved systems and methods to accurately and/or automatically utilize risk relationship analysis tools for an enterprise.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of insurance, embodiments may instead be associated with other types of insurance in addition to and/or instead of those described herein. Similarly, although certain types of insurance, businesses, and organization parameters were described in connection some embodiments herein, other types of arrangements and configurations might be used instead.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A risk relationship analysis system implemented via a back-end application computer server of an enterprise, comprising:
(a) a risk relationship data store that contains electronic records associated with a plurality of risk relationships between the enterprise and parties, and, for each risk relationship, a risk relationship identifier, a party identifier, and at least one risk relationship parameter; and
(b) the back-end application computer server, coupled to the risk relationship data store, including:
a computer processor, and
a computer memory coupled to the computer processor and storing instructions that, when executed by the computer processor, cause the back-end application computer server to:
receive a risk relationship analysis request from a user device,
extract and summarize information, by a data extractor using deep learning and natural language processing from multiple data sources, including knowledge graphs, websites, and historical loss reports,
generate, by a response generator, an accurate and contextually relevant response based on the extracted data and information in the risk relationship data store, and
transmit the relevant response to the user device.

2. The system of claim 1, further comprising one or more data extractors that include:
mechanisms for capturing enterprise data from data sources, translating it into embeddings, and storing it in a vector database,
a semantic cache reasoning service for retrieval of repetitive information, and
integration of various databases and data storage solutions for optimized performance.

3. The system of claim 1, further comprising:
a plurality of response generators, including:
a centralized orchestration component with an intent classifier and a centralized flow controller to manage information flow,
KGQuest for transforming knowledge graph queries using large language models,
TreeBERT for navigating hierarchical document structures to extract precise information,
DocuProbe for generating synthetic questions and extracting document-centric content,
DimenRAG for multi-dimensional enhanced data retrieval,
an abstractive summarizer for creating summaries based on specific templates,
a multi-stage LLM preference for verifying the accuracy of generative responses,
a stage-level human preference for continuous feedback to the intent classifier.

4. The system of claim 1, further comprising:
a system for a specialized Neuro-Symbolic Large Language Model (“NS-LLM”) agents that:
take input from the data extractor, including key questions and information from each data source, and
interact with a neuro-symbolic reasoning engine to generate responses consisting of guidance, open questions, and summaries.

5. The system of claim 1, wherein evaluation strategies for a Conversational Generative Artificial Intelligence Driven Underwriting Assistant (“CG-AIUA”) include:
a stage-level human preference involving continuous feedback from human experts at every stage of AN output generation process to ensure fluidity, coherence, and domain appropriateness, and
a multi-stage Large Language Model (“LLM”) preference employing advanced large language models to compare the output with similar ground truth texts in real-time for accuracy and relevance.

6. The system of claim 5, wherein an evaluation of the system's output indicates a preference by both human evaluators and LLM agents over human-written references.

7. The system of claim 5, further comprising:
a diverse array of roles within the CG-AIUA to simulate an underwriting process, including:
senior underwriters overseeing content production process and ensuring alignment with company objectives,
analysts managing editorial workflow, editing content, and assisting in content planning,
translators converting material from one language to another while maintaining an original text's tone, style, and context,
vertical industry specialists adapting content for specific verticals, regions, or markets to ensure relevance,
proofreaders performing final checks for grammar, spelling, punctuation, and formatting errors, and
evaluators assessing a quality of the underwriting and determining a need for further revisions based on risk formulas and other criteria.

8. The system of claim 5, further comprising:
one or more program-aided LLMs to integrate code with text to capture a required reasoning and process.

9. The system of claim 8, further comprising at least one corresponding engine that provides reasoning results.

10. An enterprise risk relationship analysis method implemented via a back-end application computer server of an enterprise, comprising:
receiving, by a computer processor of the back-end application computer server, a risk relationship analysis request from a user device;
extracting and summarizing information, by a data extractor using deep learning and natural language processing from multiple data sources, including knowledge graphs, websites, and historical loss reports;
generating, by a response generator, an accurate and contextually relevant response based on the extracted data and information in a risk relationship data store; and
transmitting the relevant response to the user device.

11. The method of claim 10, wherein one or more data extractors associated with the method include:
mechanisms for capturing enterprise data from data sources, translating it into embeddings, and storing it in a vector database,
a semantic cache reasoning service for retrieval of repetitive information, and
integration of various databases and data storage solutions for optimized performance.

12. The method of claim 10, wherein the method is further associated with a plurality of response generators, including:
a centralized orchestration component with an intent classifier and a centralized flow controller to manage information flow,
KGQuest for transforming knowledge graph queries using large language models,
TreeBERT for navigating hierarchical document structures to extract precise information,
DocuProbe for generating synthetic questions and extracting document-centric content,
DimenRAG for multi-dimensional enhanced data retrieval,
an abstractive summarizer for creating summaries based on specific templates,
a multi-stage LLM preference for verifying the accuracy of generative responses, and
a stage-level human preference for continuous feedback to the intent classifier.

13. The method of claim 10, further comprising:
taking, by a system for a specialized Neuro-Symbolic Large Language Model (“NS-LLM”) agents, input from the data extractor, including key questions and information from each data source; and
interacting, by the system for the specialized NS-LLM agents, with a neuro-symbolic reasoning engine to generate responses consisting of guidance, open questions, and summaries.

14. The method of claim 10, wherein evaluation strategies for a Conversational Generative Artificial Intelligence Driven Underwriting Assistant (“CG-AIUA”) include:
a stage-level human preference involving continuous feedback from human experts at every stage of AN output generation process to ensure fluidity, coherence, and domain appropriateness, and
a multi-stage Large Language Model (“LLM”) preference employing advanced large language models to compare the output with similar ground truth texts in real-time for accuracy and relevance.

15. The method of claim 14, wherein an evaluation of the system's output indicates a preference by both human evaluators and LLM agents over human-written references.

16. The method of claim 14, further comprising:
simulating an underwriting process having a diverse array of roles within the CG-AIUA, including:
senior underwriters overseeing content production process and ensuring alignment with company objectives,
analysts managing editorial workflow, editing content, and assisting in content planning,
translators converting material from one language to another while maintaining an original text's tone, style, and context,
vertical industry specialists adapting content for specific verticals, regions, or markets to ensure relevance,
proofreaders performing final checks for grammar, spelling, punctuation, and formatting errors, and
evaluators assessing a quality of the underwriting and determining a need for further revisions based on risk formulas and other criteria.

17. The method of claim 14, wherein one or more program-aided LLMs integrate code with text to capture a required reasoning and process.

18. The method of claim 17, further comprising at least one corresponding engine that provides reasoning results.

19. A non-transitory, computer-readable medium storing instructions, that, when executed by a processor, cause the processor to perform a enterprise risk relationship analysis method implemented via a back-end application computer server, the method comprising:
receiving, by a computer processor of the back-end application computer server, a risk relationship analysis request from a user device;
extracting and summarizing information, by a data extractor using deep learning and natural language processing from multiple data sources, including knowledge graphs, websites, and historical loss reports;
generating, by a response generator, an accurate and contextually relevant response based on the extracted data and information in a risk relationship data store; and
transmitting the relevant response to the user device.

20. The medium of claim 19, wherein one or more data extractors associated with the method include:
mechanisms for capturing enterprise data from data sources, translating it into embeddings, and storing it in a vector database,
a semantic cache reasoning service for retrieval of repetitive information, and
integration of various databases and data storage solutions for optimized performance.
